(19) United States
(12) Patent Application Publication
(10) Pub. No.: US 2010/0100414 A1
(43) Pub. Date: Apr. 22, 2010

(54) OPTIMIZATION OF ALLOCATION OF ONLINE ADVERTISEMENT INVENTORY

(75) Inventors: Long-Ji Lin, San Jose, CA (US); John Tomlin, Sunnyvale, CA (US); Danny Zhang, Mountain View, CA (US); Peiji Chen, Saratoga, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/253,326

(22) Filed: Oct. 17, 2008

(51) Int. Cl. G06Q 30/00; G06Q 10/00

(52) U.S. Cl. 705/10; 705/14.49

(57) ABSTRACT

A system for advertisement inventory allocation is disclosed, including a database to store advertisement impressions. An indexer builds a plurality of index tables each associated with an attribute that is mapped to a plurality of the impressions. An impression matcher constructs a flow network including a plurality of nodes each containing impressions of at least one corresponding attribute projected to be available during a time period, a plurality of contracts each including specific requests for impressions that satisfy a demand profile during the time period, and a plurality of arcs to connect the plurality of nodes to the plurality of contracts that match the demand profile of each contract. An optimizer optimally allocates impressions from the nodes to the contracts during the time period by solving the flow network with a minimum-cost network flow algorithm that maximizes delivery of the impressions to the contracts in a way that satisfies the corresponding demand profiles and that specifies a number of impressions to flow over each of the plurality of arcs.

### BACKGROUND

1. Technical Field

The disclosed embodiments relate to allocation of advertisement inventory, and more particularly, to optimally allocating advertisement impressions to advertising contracts according to demand profiles of the contracts by solving a minimal-cost network flow problem.

2. Related Art

The Internet has become a mass media on par with radio and television. Similar to radio and television content, Internet content is largely supported by advertising dollars. Two of the most common types of advertisements on the Internet are banner advertisements and text link advertisements, which may generally be referred to as display advertising. Banner advertisements are generally images or animations that are displayed within an Internet web page. Text link advertisements are generally short segments of text that are linked to the advertiser's web site via a hypertext link.

To maximize the impact of Internet advertising (and maximize the advertising fees that may be charged), Internet advertising services such as ad networks display advertisements that are most likely to capture the interest of the web user. An interested web user will read the advertisement and may click on the advertisement to visit a web site associated with the advertisement.

To select the best advertisement for a particular web user, an advertising service such as Yahoo! may use whatever information is known about the web user. The amount of information known about the web user, however, will vary heavily depending on the circumstances. For example, some web users may have registered with the web site and provided information about themselves while other web users may not have registered with the web site. Some registered web users may have completely filled out their registration forms whereas other registered web users may have only provided the minimal amount of information to complete the registration. Thus, the targeting information of the various different advertising opportunities will vary.

Since the quality of the advertising opportunities will vary, an Internet advertising service such as Yahoo! should be careful to use the advertising opportunities in the most optimal manner possible. For example, an advertising opportunity for an anonymous web user is not as valuable as an advertising opportunity for a web user who has registered and provided detailed demographic information. Thus, it is desirable to be able to optimally allocate the various different advertising opportunities to different advertisers and advertising campaigns. With huge numbers (into the billions) of advertising impressions available, or projected to be available, and hundreds of thousands of advertising contracts needing fulfillment, the allocation problem becomes practically unsolvable in a reasonable amount of time.

### BRIEF DESCRIPTION OF THE DRAWINGS

The system may be better understood with reference to the following drawings and description. The components in the figures are not necessarily to scale, emphasis instead being placed upon illustrating the principles of the disclosure. Moreover, in the figures, like-referenced numerals designate corresponding parts throughout the different views.

FIG. 1 is a diagram of a system designed to optimize allocation and delivery of advertisement inventory to contracts, and to optimize ad serving and bid generation with a spot market such that an online marketplace for advertisements is unified.

FIG. 2 is a diagram of an exemplary system for allocation of advertisement inventory to advertiser contracts according to demand profiles of the contracts by solving a minimal-cost network flow problem.

FIG. 3 is a flow diagram of an embodiment for building a flow network from advertisement impressions and contracts, which is solved by an optimizer to allocate forecasted impressions and to produce a delivery plan for advertisement inventory.

FIG. 4 is an exemplary flow network such as would be created by the system of FIG. 2 and the flow diagram of FIG. 3, the flow network including contracts fed by nodes of forecasted impressions, which are connected by arcs.

FIG. 5 is an exemplary flow network such as that of FIG. 4, wherein the flow network further includes artificial contracts into which artificial arcs flow from impression nodes.

FIG. 6 is an exemplary flow network such as that of FIG. 5, wherein the flow network further includes artificial nodes of forecasted impressions and penalty arcs that feed the artificial nodes into contracts.

FIG. 7 is a chart to show the relationship between a cumulative cost of failing to meet demands of a contract and the infeasibility of satisfying demand with artificial nodes.

FIG. 8 is a flow chart of an exemplary method for allocation of advertisement impressions to advertiser contracts according to demand profiles of the contracts by solving a minimal-cost network flow problem.

FIG. 9 is a flow chart of an exemplary method for allocation of advertisement impressions, which include those from artificial nodes, to advertiser contracts according to demand profiles of the contracts by solving a minimal-cost network flow problem.

### DETAILED DESCRIPTION

By way of introduction, this disclosure relates to allocation of advertisement inventory, and more particularly, to optimally allocating advertisement impressions to advertising contracts according to demand profiles of the contracts by solving a minimal-cost network flow problem. The present disclosure focuses on optimizing allocation of display advertising to demand profiles of advertising contracts that request impressions having certain targeting attributes.

In a typical scenario for a specific ad position (such as a North ad position), there are over five (5) million different kinds of impressions (supply nodes) on each day, and 10,000 ad contracts (demand nodes) to run on the same day. On average, each contract can be satisfied by hundreds of thousands of kinds of impressions. The inventory allocation problem may be formulated as a network-flow problem as will be discussed below.

Current systems create a strict and artificial separation between display inventory that is sold in advance in a guaranteed fashion (guaranteed delivery), and inventory that is sold through a real-time auction in a spot market or through other means (non-guaranteed delivery). For instance, a current system always serves to guaranteed contracts their desired quota of advertisements before serving any to non-guaranteed contracts, causing high-quality impressions to be mostly served to guaranteed contracts. While this mode of operation was acceptable when advertisers bought mostly guaranteed contracts, the shift in the industry to a mix of guaranteed and non-guaranteed contracts creates the need for a more unified marketplace whereby an impression can be allocated to a guaranteed or to a non-guaranteed contract based on the value of the impression to the different contracts. Such a unified marketplace enables a more equitable allocation of inventory, and also promotes increased competition between guaranteed and non-guaranteed contracts.

A major trend in display advertising is the increased refinement in targeting so that advertisers can reach more relevant customers. Advertisers are moving from broad targeting constraints such as “1 million Yahoo! Finance users from 1 Aug. 2008-31 Aug. 2008,” which current systems are designed to handle, to much more fine-grained constraints such as “100,000 Yahoo! Finance users from 1 Aug. 2008-8 Aug. 2008 who are California males between the ages of 20-35 and are working in the healthcare industry and like sports and autos.” This shift in targeting has deep implications for the underlying system design. First, there is a need to forecast future inventory for fine-grained targeted combinations, which requires modeling one or more correlations between different targeting attributes. Second, there is a need to manage contention in a high-dimensional targeting space with hundreds to thousands of targeting attributes because different advertisers can specify different overlapping targeting combinations, and the system needs to ensure that there is sufficient inventory to meet the needs of all accepted guaranteed contracts.

Historically, the pricing of guaranteed contracts has been decoupled from how impressions are allocated and served to the contacts. For instance, one of the current pricing systems in use only uses information about supply and demand at a coarse untargeted level, and does not consider how impressions are assigned to fine-grained targeted contracts. This creates a gap between the guaranteed price and the actual value that a guaranteed contract derives from the served impressions. The proposed system and techniques for pricing guaranteed contracts are tightly integrated with the allocation and delivery of impressions, and closely coordinate the execution of various system components.

As used herein, a property is a collection of related web pages. For example, all of the web pages under finances.yahoo.com belong to the Yahoo Finance property. A sub-property is a sub-part of a property, such as finance.yahoo.com/real-estate belongs to the Real-Estate property, which is a sub-property of Yahoo Finance. An ad position is a location on a web page where an advertisement is shown. Common ad positions are North (N), Skyscraper (SKY), and Large Rectangle (LREC). Advertisement inventory are pages available for showing advertisements on a specific ad position. Untargeted inventory forecasting is the forecasting of inventories available on a given property. Targeted inventory forecasting is the forecasting of inventories available for a given ad targeting criteria, such as targeting visitors who are at least 25 years old and have interest in real estate.

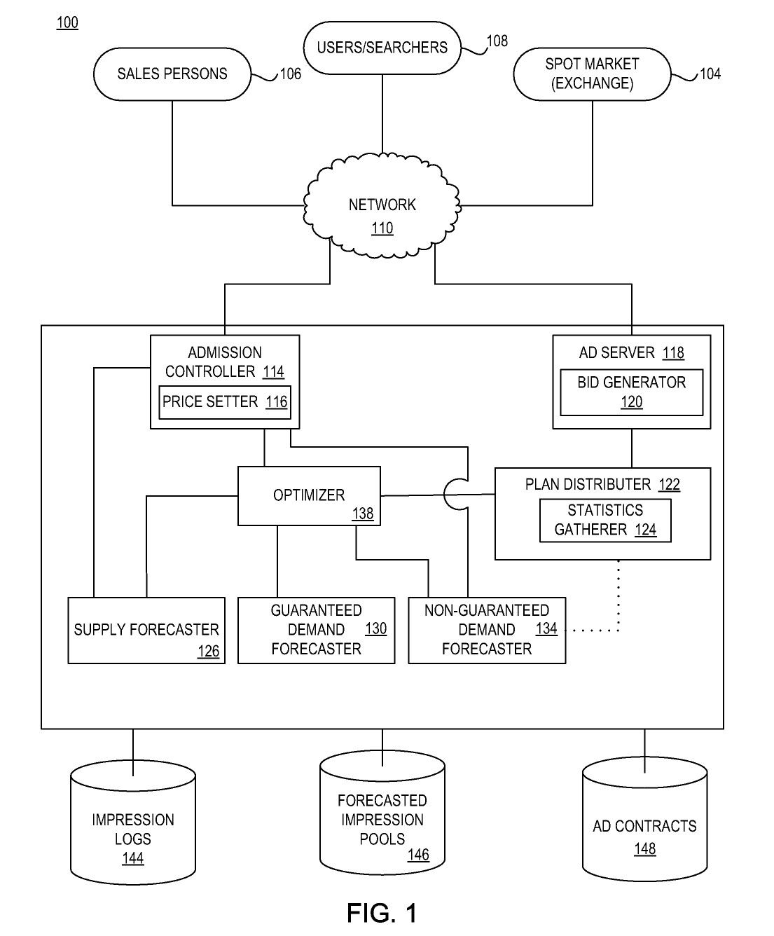

FIG. 1 is a diagram of a system 100 designed to optimize allocation and delivery of advertisement inventory to contracts, and to optimize ad serving and bid generation with a spot market 104 such that an online marketplace for advertisements is unified. The system 100 may include sales persons 106 that sell contracts; both the system 100 and the sales persons 106 communicate over a network 110. The network 110 may include the Internet or World Wide Web (“Web”), a wide area network (“WAN”), a local area network (“LAN”), and/or an extranet. The network 110 may be accessed through either a wired or wireless connection. The system also includes users (or searchers) 108 of the Internet, the Web, of an extranet, etc.

The system 100 further includes various system components, including, but not limited to: an admission controller 114 having a price setter 116, an advertisement (“ad”) server 118 having a bid generator 120, a plan distributer 122 having a statistics gatherer 124, a supply forecaster 126, a guaranteed demand forecaster 130, a non-guaranteed demand forecaster 134, and an optimizer 138. The admission controller 114 communicates over the network 110 with the sales persons 106 and may be coupled with the supply forecaster 126, the optimizer 138, and the non-guaranteed demand forecaster 134. Herein, the phrase “coupled with” is defined to mean directly connected to or indirectly connected through one or more intermediate components. Such intermediate components may include both hardware and software based components. The ad server 118 communicates over the network 110 with the users 108 and the spot market 104. The ad server 118 may be coupled with the plan distributer 122, which may in turn be coupled with the optimizer 138 and the non-guaranteed demand forecaster 134. The optimizer 138 may be coupled with the admission controller 114, the supply forecaster 126, the guaranteed demand forecaster 130, the non-guaranteed demand forecaster 134, and the plan distributer 122.

The components of the system 100 may be embodied in hardware or a combination of hardware and software executed on one or more servers coupled with the network 110. The system 100 may further include, or be coupled with, an impression log database 144 to store historical advertisement impressions, a forecasted impression pools database 146 to store forecasted impressions within impression pools, and an advertisement (ad) contracts database 148 to store guaranteed and, in some cases, non-guaranteed contracts. The impressions in the impression log database 144 are those gathered from advertisement impressions as they were served for advertisers to web pages that were visited by the users 108. As the impressions are stored, impressions logs of the database 144 also record details or attributes of each impression as they are served. The information logged in relation to each impression includes a page identification (or page/sub-page property), a user identification, an advertisement identification, a timestamp, and other information such as a browser identification. These are merely examples and additional information or attributes associated with a served impression may be gathered.

The system 100, with the supply forecaster 126, populates the forecasted impression pools database 146 with forecasted impressions from the impression logs that target users visiting certain web pages with certain demographics, geography, behavioral interests, as well as many other attributes. These targeting attributes are derived from online advertisers that would like to target users that have a certain profile and that access certain web pages. It is important for a publisher like Yahoo! to be able to forecast such available inventories of impressions before selling them.

An impression pool is a collection of impressions that share the same attributes. From the logs and other lookup tables (such as page hierarchy tables, visitor attributes tables, etc.), the system 100 obtains the following non-exhaustive information, as available, pertaining to each impression pool: page attributes such as a property of the page, a position of an advertisement on the page; visitor attributes such as age, gender, country, state, zip code, behavioral interests; time, including date and hour of the day; other attributes such as the browser used to consume the impression; and a total number of impressions similar to this impression. As one non-exhaustive example, the impression pool may include the following information: the page is on Yahoo Finance; ad impression is shown in the North position; the visitor is a male, 25 years old, living in the United States, California, having interests in finance and travel; the visit time is 3:00 PM, Jul. 2, 2009 (a time in the future); the browser used is Internet Explorer 6.0; and 120 impressions are forecasted to be like this one, with the same page attributes, the same user attributes, the same visit time, and the same browser used.

To save storage and computation time, the system 100 may process and keep a subset (such as 4%) of the impression logs of the database 144 that will be used to conduct inventory forecasting that populates the forecasted impression pools database 146. The supply forecaster 126 then uses the historical impression logs from the database 144 to forecast future impression inventories, which will be discussed in more depth below.

The admission controller 114 interacts over the network 110 with the sales persons 106 that sell guaranteed contracts to advertisers. A sales person 106 issues a query with a specified target (e.g., “Yahoo! finance users who are California males who likes sports and automobiles”) and the admission controller 114 returns to the sales person 106 the information about the available inventory for the target and the associated price of that inventory. The sales person 106 can then book a contract accordingly, which is stored in the ad contracts database 148.

The operation of the system 100 may be conducted off-line by the optimizer 138. The optimizer 138 periodically obtains a forecast of supply (forecasted impressions), guaranteed demand (expected guaranteed contracts), and non-guaranteed demand (expected bids in the spot market 104), and matches supply to demand using an overall objective function (discussed below). The optimizer 138 then sends a summary (or delivery) plan of the optimized result to the admission controller 114 and the plan distributer 122. The plan distributer 122 sends the plan to the ad server 118. The plan produced by the optimizer 138 is updated every few hours, or as computation time permits, based on new estimates for supply, demand, and delivered impressions.

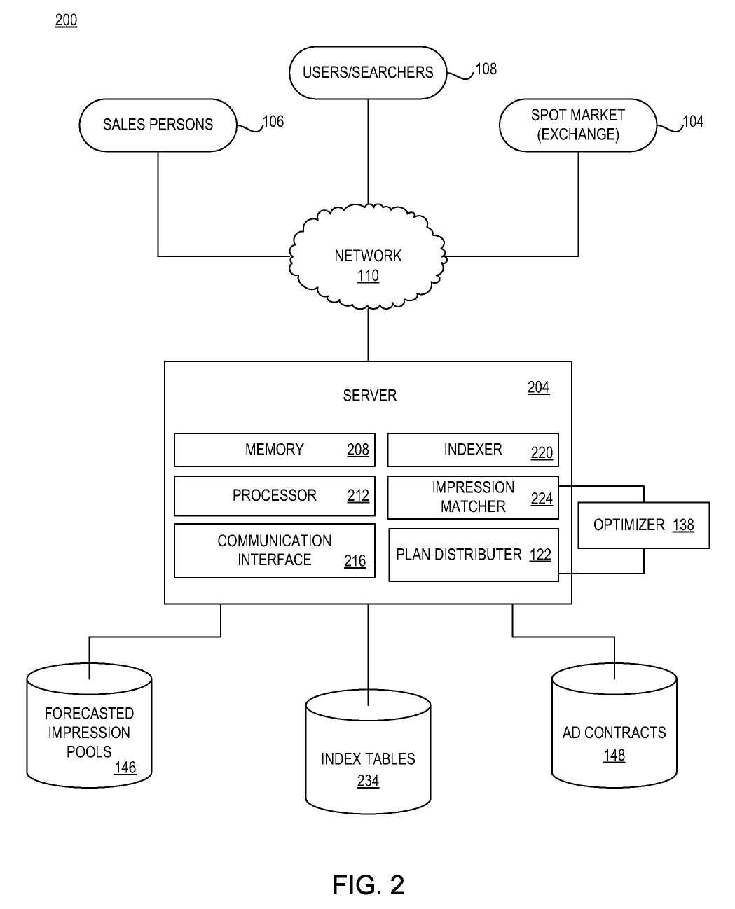

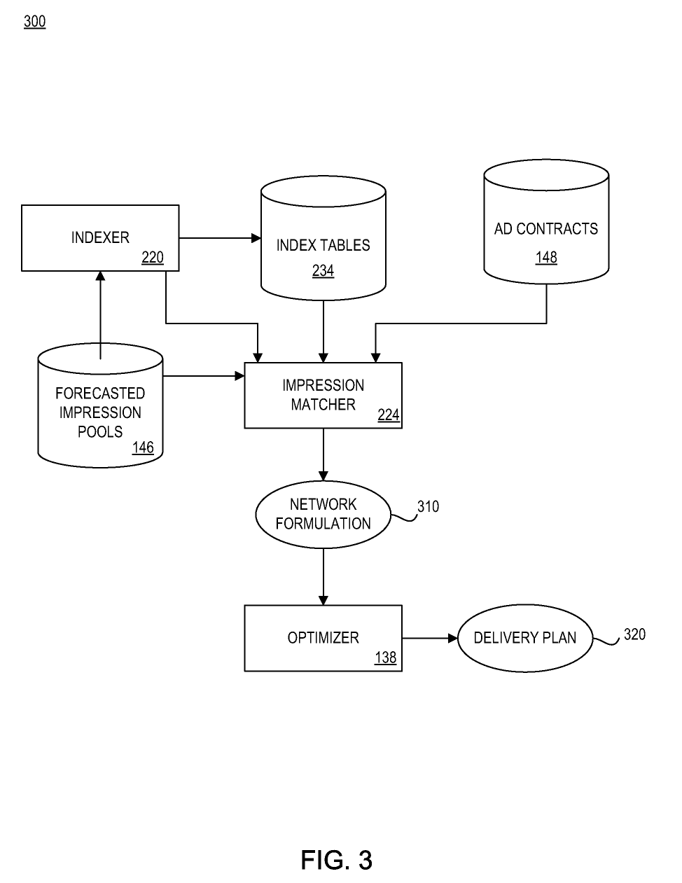

When a sales person 106 issues a query for some duration in the future that targets certain attributes associated with advertisement impressions, the system 100 first invokes the supply forecaster 126 to identify how much inventory is available for that target and duration. As mentioned, targeting queries can be very fine-grained in a high-dimensional space as an increased number of attributes are targeted. Most data can be thought of as tables, where each row of the table represents an object or a record, and each column represents one attribute of the record. Accordingly, a plurality of index tables (FIGS. 2-3) may be used, each associated with an attribute value (or attribute) to generate the high-dimensional space. Each column of an index table is also referred to as a dimension of the data. Many scientific datasets have tens or hundreds of dimensions, and are thus called high-dimensional data. The supply forecaster 126 may use a scalable, multi-dimensional database indexing technique with bit-map indices to capture and store attribute value data, which is then searchable through a reverse look-up technique. See Kesheng Wu, FastBit: An Efficient Indexing Technology for Accelerating Data-Intensive Science, Journal of Physics: Conference Series 16, 556-560 (2005). Although FastBit was originally designed to provide for quick lookup of scientific data, it or other indexing techniques may be employed to index impressions according to attribute, and to provide for quick look up of those impressions in building a flow network as discussed below.

Another aspect of the system 100 is directed to contention between multiple contracts. For example, assume contention between these two contracts: “Yahoo!finance users who are California males” and “Yahoo! users who are aged 20-35 and interested in sports.” The system 100 needs to determine how many impressions match both contracts so that it does not double-count the inventory when quoting available inventory to the sales person 106. In order to deal with this contention in a high-dimensional space, the supply forecaster 126 produces impression samples by sampling the forecasted impressions of the forecasted impression pools database 146. Forecasted impressions, as used herein, represent the various kinds of impressions available in the future, and their volume. The system 100 can use the sample of forecasted impressions to determine how many contracts, during a future period of time, can be satisfied by each forecasted impression.

Given a delivery plan, the ad server 118 works as follows. The ad server 118 receives an advertisement opportunity when a user is visiting a web page. The ad opportunity is tagged with targeting attributes, including webpage attributes, user attributes, time-based attributes, and other targeting attributes. Searching the delivery plan, the ad server 118 finds all the contracts relevant to the ad opportunity and then selects a contract probabilistically according to the delivery plan. With additional knowledge about non-guaranteed demand (from the non-guaranteed demand forecaster 134, for instance), the bid generator 120 generates a bid for the chosen contract. The contract and the bid are then sent to the exchange 104 to compete with other non-guaranteed contracts. Note that remaining inventory, or those forecasted impressions not allocated to guaranteed contracts by the admission controller 114, may be used to bid on non-guaranteed contracts in the spot market 104. Accordingly, the system 100 seeks to unify a marketplace of guaranteed contracts, non-guaranteed contracts, and advertisement impressions (or inventory) that may meet demands of those contracts in a way that optimizes delivery of forecasted impressions to both the non-guaranteed and guaranteed contracts.

FIG. 2 is a diagram of an exemplary system 200 for allocation of advertisement inventory to advertiser contracts according to demand profiles of the contracts by solving a minimal-cost network flow problem. The system 200 may be integrated within the system 100 as a subpart thereof. For instance, the system 200 may include at least portions of the optimizer 138 and the ad server 118, as well as the supply and demand forecasters 126, 130, and 134. More particularly, the system 200 may include a server 204, which may in turn include: a memory 208, a processor 212, a communication interface 216, an indexer 220, an impression matcher 224, the plan distributer 122, and the optimizer 138. The optimizer 138 may be located outside the server 204 and be coupled with the server 204.

The server 204 may be coupled with the forecasted impression pools database 146, the ad contracts database 148, and an indexed tables database 234. The communication interface 216 enables communication of the server 204 over the network 110 with the sales persons 106 and the spot market 104 as well as with the users (searchers) 108. The functioning of the components is enabled by the memory 208 and the processor 212 among other hardware and/or software components such as is known in the art. The details of operation of the indexer 220, the impression matcher 224, and the optimizer 138 are explained in more detail with reference to the flow diagram of FIG. 3.

Ad contracts located in the ad contracts database 148 may include, but are not limited to, the following information or attributes: a campaign duration; a property and ad position where the impressions will be displayed; a targeting profile; and a total number of impressions to be delivered. As one non-exhaustive example, the contract may include the following information: the ad campaign will run from Jan. 1, 2009 to Dec. 31, 2009 (the time period); the ad campaign will run on Yahoo Finance, at the North position; the ad campaign will target users who are male and have interests in travel; and the goal of the campaign is to deliver 10 million such impressions during the time period.

The system 100, accordingly, seeks to match the forecasted impressions from the forecasted impression pools database 146 with ad contracts from the ad contracts database 148 in order to determine what impressions can satisfy the given contracts and how many such impressions will be available during an ad campaign. There could be millions of impression pools and a few hundred thousand contracts to match.

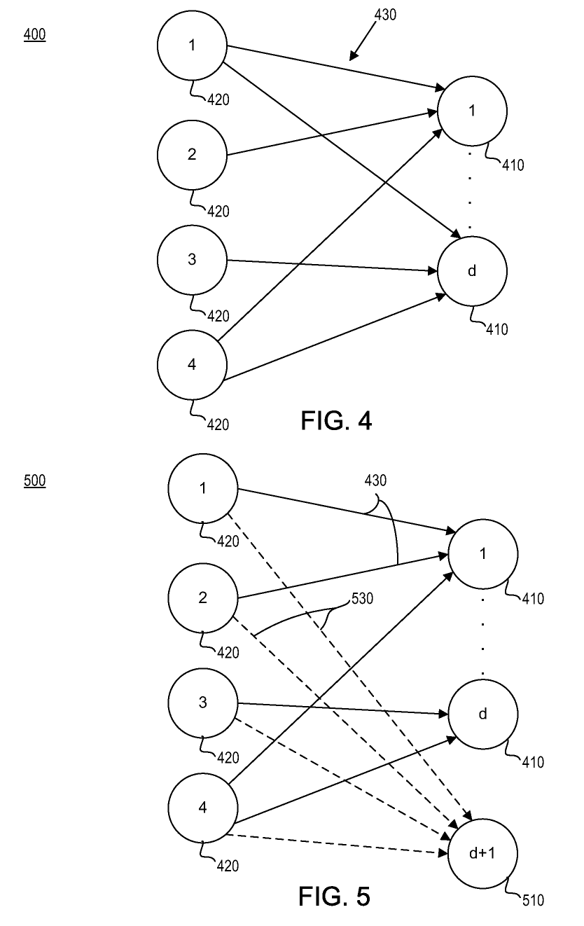

FIG. 3 is a flow diagram 300 of an embodiment for building a flow network (400 in FIG. 4) from advertisement impressions and contracts, which is solved by the optimizer 138 to allocate forecasted impressions and to produce a delivery plan for advertisement inventory. The flow diagram 300 illustrates the flow of forecasted impressions from the forecasted impression pools database 146, indexed by the indexer 220 in the index tables database 234, and to be matched by the impression matcher 224 with contracts located in the ad contracts database 148. The result, at block 310, is a network formulation of forecasted impressions sharing certain attributes within impression nodes (or pools) connected to contracts that meet request demands of those contracts (FIG. 4). The optimizer 138 receives the network formulation and, at block 320, outputs a delivery plan that optimally allocates the forecasted impressions to the contracts by solving the network formulation with a minimum-cost network flow algorithm.

FIG. 4 is an exemplary flow network 400 such as would be created by the system of FIG. 2 and the flow diagram of FIG. 3; the flow network 400 includes a plurality of contracts 410 fed by a plurality of nodes 420 of forecasted impressions, which are connected by a plurality of arcs 430. The forecasted impressions from the database 146 are the impressions that will be organized into the plurality of nodes 420 based on sharing at least one of the same attributes. There may be millions of forecasted impression nodes 420, each of which may contain dozens or even hundreds of attributes. Sequential scanning of the data is too slow a way to find all the data that match a certain query (for instance, “property=Finance and age>30 and country=U.S.”).

With reference to FIGS. 3 and 4, the indexer 220 retrieves impression samples from the forecasted impression pools database 146, and builds a plurality of index tables each having an attribute value to be mapped or associated with the impression nodes 420 that have the attribute corresponding to the attribute value. Note that this disclosure will use the terms impression pools and impression nodes interchangeably. The index tables are stored in the index tables database 234. Due to large datasets of impression pools that are mapped to, in many cases, multiple attributes via the index tables, efficiently identifying impression nodes 420 that share more than one attribute, e.g., as may be required by demand profiles of certain contracts 410, poses a great challenge. That is, the attributes of some impression nodes 420 throughout the plurality of nodes 420 may overlap each other in ways advantageous to targeting requests of similar attributes by demand profiles of one or more contracts 410. But, with increasing complexity and granularity of attributes, as discussed above, the network flow problem becomes more difficult to solve. To enact the mapping or association between index tables and attributes, the indexer 220 may employ a scalable, multi-dimensional indexing technique that uses bit-map indices to capture and store attribute value data in the plurality of index tables.

One such multi-dimensional indexing technique includes FastBit, which addresses the challenge of efficiently searching large, high-dimensional datasets. See Wu, infra. Usually, the data to be searched is read-only and consists of volumes of scientific data. FastBit takes advantage of this fact. Since most database management systems (DBMS) are built for frequently-modified data, FastBit can perform searching operations significantly faster than those DBMS. In the present disclosure, it is proposed to use technology such as FastBit in a different context, applied to informational attribute values of forecasted impressions and demand requests (or profiles) of contracts 410. First, FastBit scans the whole dataset (in this case, forecasted impressions from impression nodes 420), and builds a plurality of index tables, one for each attribute. Once the index tables are built, the data can be queried very efficiently.

Conceptually, most data can be thought of as tables, where each row of the table represents an object or a record, and each column represents one attribute of the record. To accommodate frequent changes in records, a typical DBMS stores each record together on disk. This allows easy update of the records, but in many operations the DBMS effectively reads all attributes from disk in order to access a few that are relevant for a particular query. FastBit stores each attribute together on disk, which allows one to easily access the relevant columns without involving any other columns. Although an update may take longer to execute—because the update usually comes in the form of bulk appended operations—the new records can be integrated into existing tables efficiently. In database theory, separating out the values of a particular attribute is referred to as a projection. For this reason, using column-wise organized data to answer user queries is also known as the projection index.

User queries usually involve conditions on several attributes; they are known as multi-dimensional queries. For multi-dimensional queries on high-dimensional data, the projection index performs better than most well-known indexing schemes. Since FastBit uses column-wise organization for user data without any additional indices, it is using the projection index, which is already very efficient. FastBit indexing technology further speeds up the searching operations. The indexer 220 may use the FastBit (or similar database searching technology) to build index tables that map attribute values to forecasted impressions.

The following exemplifies how FastBit works in the context of the indexer 220. Assume there are 6 million impression nodes 420, each of which is assigned a unique identifier from 1 to 6 million. The indexer 220 will build a bit vector (or index table) for a single attribute value such as “gender=female.” The bit vector is 6 million bits long. Each bit is either 1 or 0, indicating whether the corresponding impression node 420 contains the “gender=female” attribute. The indexer 220 will build such bit vectors for all possible attribute values, such as “gender=male,” “age=32,” “behavior_interest=music,” “hour_of_day=12,” “country=US,” etc. With a clever encoding scheme, FastBit is able to condense each long bit vector into a storage of far fewer than 6 million bits, saving both memory and processing time.

The impression matcher 224 may also use FastBit to more efficiently query the index tables database 234 and build the flow network 400, as discussed below. To illustrate how the impression matcher 234 works, consider the following query: “gender=female and behavior_interest=music and country=US.” First, the impression matcher 224 retrieves the three bit vectors (or index tables) corresponding to “gender=female,” “behavior_interest=music,” and “country=US.” The impression matcher 224 then performs a bit-wise “AND” operation on the three bit vectors. The output bit vector indicates all the impression nodes 420 that have all of these three attribute values. FastBit also supports a bit-wise “OR” operation.

The indexer 220, the index tables database 234, the forecasted impressions database 146, and the ad contracts database 148 may all feed their respective data into the impression matcher 224. The impression matcher 224 then constructs the flow network 400, at block 310, which includes the plurality of the nodes 420 each containing forecasted impressions of at least one corresponding attribute projected to be available during a time period. The flow network 400 also includes the plurality of the contracts 410 each including specific requests for impressions that satisfy a demand profile during the time period, and the plurality of the arcs 430 to connect the plurality of nodes 420 to the plurality of contracts 410 that match the demand profile of each contract 410.

In this way, the inventory allocation problem can be represented as a network-flow optimization problem. The model is a bipartite network with supply nodes i=1, . . . , s and demand nodes j=1, . . . , d. Each supply node 420, assumed to be composed of forecasted impressions, has impressions available for delivery to the demand nodes 410 representing guaranteed contracts 410. The network 400 has an arc or link (i,j) (430) from i to j if impression node i can be used as a source by contract j. The system 100, 200 may represent the supply (number of impressions available at node i) by sᵢ and the demand associated with contract j by dⱼ. With the flow network 400 formulated, the optimizer 138 may then solve the flow network 400 as a minimal-cost network flow problem based on the impression nodes 420 and the demand profiles of the various contracts 410.

The objective of a network-flow optimizer 138 is to satisfy the demands (or contracts 410) as much as possible, given the available supply (or forecasted impressions) through allocation of the forecasted impressions. The optimizer 138 outputs a delivery plan, at block 320, which includes a proposed allocation of the impression nodes 420 to the contracts 410 over the time period, which may also specify the number of forecasted impressions flowing over each arc 430. Block 320 may be identical to the plan distributer 122. The delivery plan may also specify a probability that each forecasted impression within the nodes 420 will be delivered to a particular contract 410. It will be apparent to one of ordinary skill in the art that a raw number of allocated forecasted impressions that may be output by the optimizer 138 may be converted, by software know in the art, to a percentage value of the impression node 420 to specific contracts 410. This may include less than 100% allocation of a single impression node 420 to some contracts 410, wherein allocation of the impression node 420 is apportioned across more than one contract 410. Furthermore, upon receipt of an impression that is not stored in the forecasted impression pools database 146, the optimizer 138 may search for an impression in the forecasted impression pools database 146 that is similar to the received impression, and use the delivery plan of the impression for allocation of the received impression.

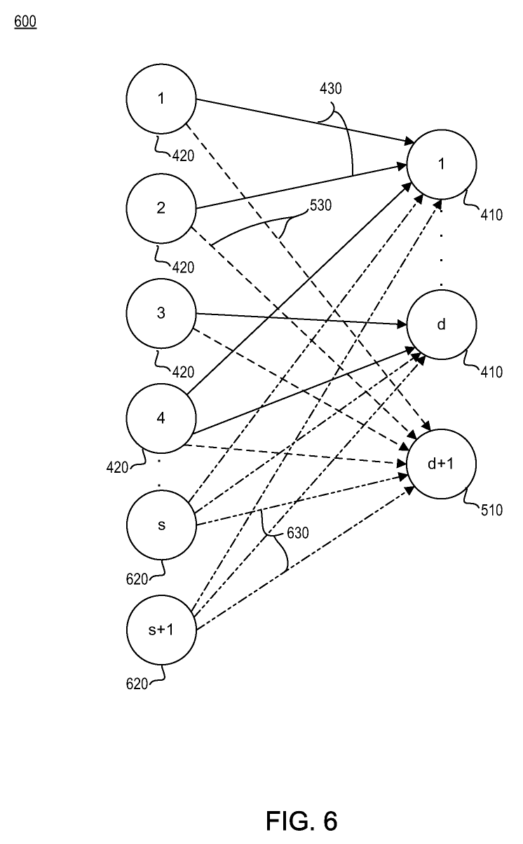

FIG. 5 is an exemplary flow network 500 such as that of FIG. 4, wherein the flow network 500 further includes artificial contracts 510 into which artificial arcs 520 flow from impression nodes 420. Specialized network solvers (or optimizer 138), discussed below, typically require the model to be “balanced,” or in other words, that the total inventory supply equals the total demand. One difficulty may be that the total supply exceeds the total demand. To overcome such an imbalance, the system 100, 200 can add an artificial contract 510 (or artificial sink 510), which can accept any of the impression nodes 420, and has demand equal to at least the net excess supply. In practice, the system 100, 200 can set the demand at artificial contract d+1 to be the total (real) supply of the impression nodes 420. The artificial arcs 530 have cost larger than that of any other arcs, and hence the supply will flow to the artificial contract 510 only when there is excess supply because the optimizer 138 attempts to minimize the overall cost of flow. Note that the high cost also applies to the penalty arcs 630 discussed in FIG. 6 that feed into the artificial contracts 510.

FIG. 6 is an exemplary flow network 600 such as that of FIG. 5, wherein the flow network 600 further includes artificial nodes 620 of impressions and penalty arcs 630 that feed the artificial nodes 620 into the contracts 410 and any artificial contracts 510. A network model may be infeasible because some contracts 410 do not get sufficient supply to satisfy them. To obtain a sensible solution, the system 200 creates artificial supply node(s) 620 that have enough supply to satisfy all demands, but only at a penalty cost that exceeds any of the real costs, but that is less than the cost of the artificial arcs 530, 630 that connect to artificial contracts 510.

All contracts, including the artificial contract 510, can get supply from the artificial supply nodes 620. In the worst case, all real contracts 410 have to get their supply from one or more artificial supply nodes 620. Hence, the system 200 can set the inventory of each artificial node 620 to be the total demand of the real contracts 410. Because the cost of the artificial arcs 530 exceeds any of the real cost, the network-flow optimizer 138 feeds artificial impressions to the real contracts 410 only when there is a lack of real impressions. The term “penalty” in the arcs 630, therefore, signify that costs are involved with linking artificial arcs 630 with contracts 410 due to the fact that the impression samples are artificial and do not satisfy any demands in reality. Impressions will have to be found in the future to plug the holes for actual delivery of forecasted impressions represented from the artificial nodes 620 in the flow network 600, or else some contracts 410 will be under-delivered. The specialized solver (or optimizer 138), which is discussed below, may track the number of artificial impressions required to balance out the flow network 400, 500 in order to solve the same as a minimal-cost network flow problem, and report that number with the delivery plan.

Once a network-flow problem is formulated, the optimizer 138 may identify one or more artificial (or penalty) arcs 630 that flow into each contract 410 from one or more corresponding artificial nodes 620 that satisfy requests of demand profiles of the contracts 410 with artificial supply. The optimizer 138 may then eliminate all of the artificial nodes 620 by reducing the size of the demand at the contracts 410 by the total amount of the flow into the artificial nodes 620 on the artificial arcs 630. The resulting model no longer needs the artificial nodes 620 and penalty arcs 630 to be feasible, which may be removed.

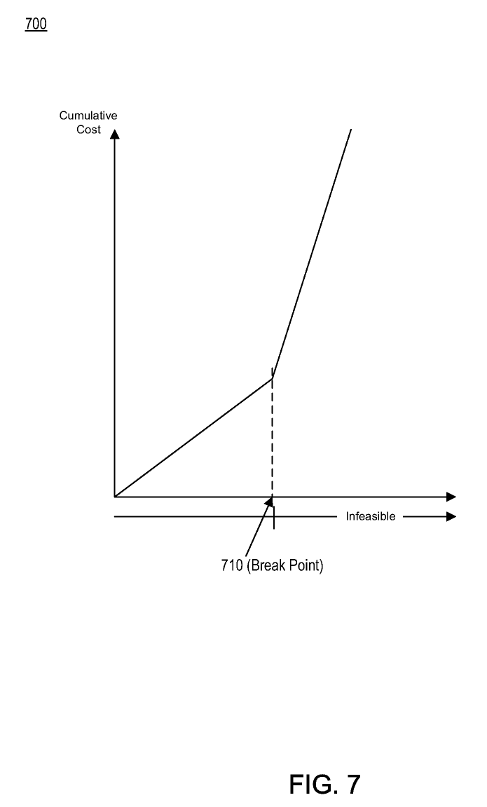

FIG. 7 is a chart 700 to show the relationship between a cumulative cost of failing to meet demands of a contract 410 and the infeasibility of satisfying demand with artificial nodes 620. In practice, there may be several artificial sources that can provide artificial inventory 620 at several varying cost levels to model an increasing cost by a lack of forecasted impressions that meet a contract 410, 510. The curve in FIG. 7 displays this phenomenon, as well as a break point 710 on the curve at which the cost increases when a cheaper artificial source 620 is exhausted. There may be several such break points 710 along the curve.

The minimum-cost flow problem is to find a flow of minimum cost, or in other words, optimal flow of the flow network 400. With further reference to FIGS. 3 through 6, there are multiple ways to solve the minimal cost network-flow problem by the optimizer 138. One of the simplest is to use a standard linear programming (LP) solver such as the Cplex (log.com) or Xpress-MP (dashoptimization.com) commercial codes, or an open source code such as the COIN-OR Clp code (coin-or.org). The Xpress-MP is a suite of mathematical modeling and optimization tools used to solve linear, integer, quadratic, non-linear, and stochastic programming problems. An Xpress-Optimizer of the Xpress-MP suite features optimization algorithms which enable solving linear problems (LP), mixed integer problems (MIP), quadratic problems (QP), mixed integer quadratic problems (MIQP) quadratically constrained problems (QCQP) and convex general non-linear problems (NLP).

An alternative is to the solvers listed above it to use a specialized minimum-cost, network flow solver such as CS2 (igsystems.com/cs2/index.html). CS2 is an efficient implementation of a scaling push-relabel algorithm for minimum-cost, flow-transportation problems. Andrew V. Goldberg, An Efficient Implementation of a Scaling Minimum-Cost Flow Algorithm, Journal of Algorithms, vol. 22-1, pages 1-29 (January 1997). The CS2 network flow solvers are typically much faster than a standard LP solver on this class of problems. However, they typically require a feasible, balanced model as input, as discussed above. Hence, the need to make the modifications to the model of the flow network 400, 500, 600 as described above in FIGS. 4-6. Other solvers as may be known or developed in the art may also be suitable.

As discussed above, the output of the optimizer 138 is a delivery plan that specifies the number of forecasted impressions flowing over each arc (i,j). When suitably scaled, this solution can be read as a fraction yᵢⱼ/sᵢ of the forecasted impression node i should be used to satisfy the demand of contract j, where yᵢⱼ is the flow from i to j. In terms of instruction to the server 204, the solution amounts to a series of orders such as:

Impression node 1: 50% goes to Contract 1, 20% to Contract 12, . . .

Impression node 2: 30% to Contract 2, 15% to Contract 15, . . .

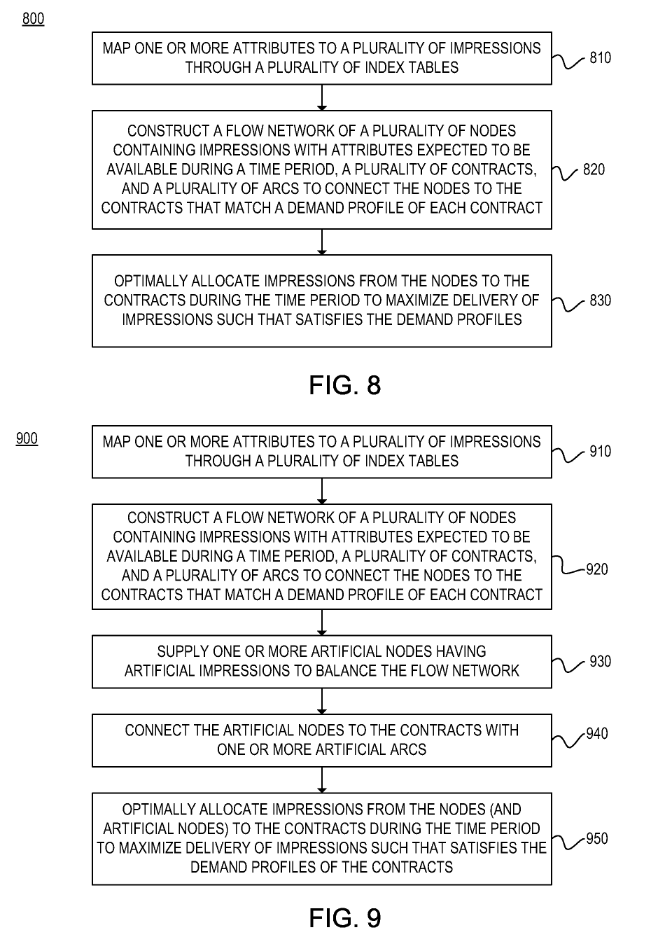

FIG. 8 is a flow chart 800 of an exemplary method for allocation of advertisement impressions to advertiser contracts according to demand profiles of the contracts by solving a minimal-cost network flow problem. At block 810, the indexer 220 maps one or more attributes to a plurality of the impressions through a plurality of index tables, each index table related to an attribute, wherein the plurality of impressions include advertisement inventory. At block 820, the impression matcher 224 constructs a flow network including a plurality of nodes each containing impressions of at least one corresponding attribute projected to be available during a time period, a plurality of contracts each including specific requests for impressions that satisfy a demand profile during the time period, and a plurality of arcs to connect the plurality of nodes to the plurality of contracts that match the demand profile of each contract. At block 830, the optimizer 138 optimally allocates impressions from the plurality of impression nodes to the plurality of contracts during the time period by solving the flow network with a minimum-cost network flow algorithm that maximizes delivery of the plurality of impressions to the plurality of contracts in a way that satisfies the corresponding demand profiles, wherein the allocation specifies a number of impressions to flow over each of the plurality of arcs.

FIG. 9 is a flow chart 900 of an exemplary method for allocation of advertisement impressions, which include those from artificial nodes, to advertiser contracts according to demand profiles of the contracts by solving a minimal-cost network flow problem. At block 910, the indexer 220 maps one or more attributes to a plurality of the impressions through a plurality of index tables, each index table related to an attribute, wherein the plurality of impressions comprise advertisement inventory. At block 920, the impression matcher 224 constructs a flow network including a plurality of nodes each containing impressions of at least one corresponding attribute projected to be available during a time period, a plurality of contracts each including specific requests for impressions that satisfy a demand profile during the time period, and a plurality of arcs to connect the plurality of nodes to the plurality of contracts that match the demand profile of each contract. At block 930, the impression matcher 224 supplies one or more artificial nodes having artificial impressions to balance the flow network. At block 940, the one or more artificial nodes are connected to the plurality of contracts with one or more artificial arcs when the plurality of impressions are insufficient to satisfy the requests for impressions from the plurality of contracts. At block 950, the optimizer 138 optimally allocates impressions from the plurality of nodes and the one or more artificial nodes to the plurality of contracts during the time period by solving the flow network with a minimum-cost network flow algorithm that maximizes delivery of the impressions to the plurality of contracts in a way that satisfies the corresponding demand profiles, wherein the allocation specifies a number of impressions to flow over each of the plurality of arcs and over the one or more artificial arcs.

The optimizer 138 may also supply one or more artificial contracts to balance the flow network, and connect the one or more artificial contracts with corresponding one or more impressions with artificial arcs when the plurality of impressions is in excess of those required to satisfy the request for impressions from the plurality of contracts.

In the foregoing description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine or computer-readable medium having stored thereon instructions that may be used to program a computer (or other electronic device) to perform processes described herein. The machine or computer-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A system for advertisement inventory allocation, comprising:
a processor and a database coupled with the processor to store impressions comprising advertisement inventory;
an indexer coupled with the database and the processor, the indexer to build a plurality of index tables each associated with an attribute and to map the plurality of index tables to a plurality of the impressions;
an impression matcher coupled with the processor, the database, and the indexer, wherein the impression matcher constructs a flow network comprising a plurality of nodes each containing impressions of at least one corresponding attribute projected to be available during a time period, a plurality of contracts each including specific requests for impressions that satisfy a demand profile during the time period, and a plurality of arcs to connect the plurality of nodes to the plurality of contracts that match the demand profile of each contract; and
an optimizer coupled with the impression matcher, the optimizer to optimally allocate impressions from the plurality of nodes to the plurality of contracts during the time period by solving the flow network with a minimum-cost network flow algorithm that maximizes delivery of the plurality of impressions to the plurality of contracts in a way that satisfies the corresponding demand profiles and that specifies a number of impressions to flow over each of the plurality of arcs.

2. The system of claim 1, wherein the optimizer outputs a delivery plan that specifies a probability that each impression will be delivered to a particular contract.

3. The system of claim 2, wherein the optimizer comprises a linear program solver.

4. The system of claim 2, wherein the indexer employs a multi-dimensional indexing technique that uses bit-map indices to capture and store attribute impression data, wherein the plurality of indexed tables are mapped to the plurality of impressions through the bit-map indices.

5. The system of claim 2, wherein upon receipt of an impression not stored in the database, the optimizer searches for an impression in the database that is similar to the received impression, and uses the delivery plan of the impression for the received impression.

6. The system of claim 2, wherein the optimizer calculates a number of impressions in one or more of the plurality of nodes to allocate to each one of the plurality of requests using as inputs the number of impressions projected to be available in each of the plurality of nodes during the time period and a total requested number of impressions for each demand profile.

7. The system of claim 1, wherein the impression matcher supplies one or more artificial nodes having artificial impressions to balance the flow network, and connects the artificial nodes to the plurality of contracts with one or more penalty arcs when the plurality of impressions are insufficient to satisfy the requests for impressions from the plurality of contracts.

8. The system of claim 7, wherein the optimizer:
identifies the penalty arcs and corresponding artificial nodes that satisfy requests of demand profiles of the plurality of contracts; and
eliminates the identified artificial nodes and penalty arcs by reducing the number of requests of the demand profiles of the plurality of contracts by the total amount of the flow into the artificial nodes on the penalty arcs.

9. The system of claim 1, wherein the impression matcher supplies one or more artificial contracts, to balance the flow network, and connects thereto impressions from the plurality of nodes with artificial arcs when the plurality of impressions are in excess of those required to satisfy the request for impressions from the plurality of contracts.

10. A computer-implemented method for advertisement inventory allocation using a computer having a processor and memory, the method comprising:
mapping, by an indexer coupled with a database of impressions, one or more attributes to a plurality of the impressions through a plurality of index tables, each index table related to an attribute, wherein the plurality of impressions comprise advertisement inventory;
constructing, by an impression matcher coupled with the indexer, a flow network comprising a plurality of nodes each containing impressions of at least one corresponding attribute projected to be available during a time period, a plurality of contracts each including specific requests for impressions that satisfy a demand profile during the time period, and a plurality of arcs to connect the plurality of nodes to the plurality of contracts that match the demand profile of each contract; and
optimally allocating, by an optimizer coupled with the impression matcher, impressions from the plurality of nodes to the plurality of contracts during the time period by solving the flow network with a minimum-cost network flow algorithm that maximizes delivery of the plurality of impressions to the plurality of contracts in a way that satisfies the corresponding demand profiles, wherein the allocation specifies a number of impressions to flow over each of the plurality of arcs.

11. The method of claim 10, further comprising:
outputting a delivery plan by the optimizer that specifies a probability that each impression will be delivered to a particular contract, wherein the delivery plan includes the optimization performed by the optimizer.

12. The method of claim 11, further comprising:
employing, by the impression matcher, a multi-dimensional indexing technique that uses bit-map indices to capture and store attribute impression data, wherein the plurality of indexed tables are mapped to the plurality of impressions through the bit-map indices.

13. The method of claim 11, further comprising:
searching for an impression in the database that is similar to the received impression where the received impression is not in the database; and
using the delivery plan of the impression for allocation of the received impression to the plurality of contracts.

14. The method of claim 11, further comprising:
calculating, by the optimizer, a number of impressions in one or more of the plurality of nodes to allocate to each one of the plurality of requests using as inputs the number of impressions projected to be available in each of the plurality of nodes during the time period and a total requested number of impressions for each demand profile.

15. The method of claim 10, further comprising:
supplying one or more artificial nodes having artificial impressions to balance the flow network; and
connecting the one or more artificial nodes to the plurality of contracts with one or more artificial arcs when the plurality of impressions are insufficient to satisfy the requests for impressions from the plurality of contracts.

16. The method of claim 15, further comprising:
identifying the artificial arcs and corresponding artificial nodes that satisfy requests of demand profiles of the plurality of contracts; and
eliminating the identified artificial nodes and arcs by reducing the number of requests of the demand profiles of the plurality of contracts by the total amount of the flow into the artificial nodes on the artificial arcs.

17. The method of claim 11, further comprising the impression matcher:
supplying one or more artificial contracts to balance the flow network; and
connecting the one or more artificial contracts with corresponding one or more impressions from the plurality of nodes with artificial arcs when the plurality of impressions are in excess of those required to satisfy the request for impressions from the plurality of contracts.

18. A computer-implemented method for advertisement inventory allocation using a computer having a processor and memory, comprising:
mapping, by an indexer coupled with a database of impressions, one or more attributes to a plurality of the impressions through a plurality of index tables, each index table related to an attribute, wherein the plurality of impressions comprise advertisement inventory;
constructing, by an impression matcher coupled with the indexer, a flow network comprising a plurality of nodes each containing impressions of at least one corresponding attribute projected to be available during a time period, a plurality of contracts each including specific requests for impressions that satisfy a demand profile during the time period, and a plurality of arcs to connect the plurality of nodes to the plurality of contracts that match the demand profile of each contract;
supplying, by the impression matcher, one or more artificial nodes having artificial impressions to balance the flow network;
connecting the one or more artificial nodes to the plurality of contracts with one or more artificial arcs when the plurality of impressions are insufficient to satisfy the requests for impressions from the plurality of contracts; and
optimally allocating, by an optimizer coupled with the impression matcher, impressions from the plurality of nodes and the one or more artificial nodes to the plurality of contracts during the time period by solving the flow network with a minimum-cost network flow algorithm that maximizes delivery of the impressions to the plurality of contracts in a way that satisfies the corresponding demand profiles, wherein the allocation specifies a number of impressions to flow over each of the plurality of arcs and over the one or more artificial arcs.

19. The method of claim 18, further comprising:
outputting a delivery plan by the optimizer that specifies a probability that each impression will be delivered to a particular contract.

20. The method of claim 19, further comprising:
employing, by the impression matcher, a scalable, multi-dimensional indexing technique that uses bit-map indices to capture and store attribute impression data, wherein the plurality of indexed tables are mapped to the plurality of impressions through the bit-map indices.

21. The method of claim 19, further comprising:
searching for a impression in the database that is similar to the received impression where the received impression is not in the database; and
using the delivery plan of the impression for allocation of the received impression to the plurality of contracts.

22. The method of claim 18, further comprising:
identifying the artificial arcs and corresponding artificial nodes that satisfy requests of demand profiles of the plurality of contracts; and
eliminating the identified artificial nodes and arcs by reducing the number of requests of the demand profiles of the plurality of contracts by the total amount of the flow into the artificial nodes on the artificial arcs.

23. The method of claim 18, further comprising the impression matcher:
supplying one or more artificial contracts to balance the flow network; and
connecting the one or more artificial contracts with corresponding one or more impressions with artificial arcs when the plurality of impressions is in excess of those required to satisfy the request for impressions from the plurality of contracts.

24. The method of claim 18, wherein the optimizer comprises a minimum-cost, network-flow solver or a linear program solver.

25. The method of claim 18, wherein the one or more artificial arcs comprise penalty arcs that represent a penalty cost for each artificial impression required to satisfy the demand profile of a contract.
